(19) United States
(12) Patent Application Publication
(10) Pub. No.: US 2004/0216610 A1
(43) Pub. Date: Nov. 4, 2004

(54) GAS PROCESSING SYSTEM COMPRISING A WATER CURTAIN FOR PREVENTING SOLIDS DEPOSITION OF INTERIOR WALLS THEREOF

(76) Inventors: Glenn Tom, New Milford, CT (US); Shawn Ferron, Martinez, CA (US); Hugh Connell, Napa, CA (US); Keith Kaarup JR., San Francisco, CA (US); Len Todd, Napa, CA (US)

Correspondence Address: ATMI, INC., 7 COMMERCE DRIVE, DANBURY, CT, 06810, US

(21) Appl. No.: 10/249,703

(22) Filed: May 1, 2003

(51) Int. Cl. B01D 47/00

(52) U.S. Cl. 95/149; 96/327; 96/272; 96/273

(57) ABSTRACT

The present invention relates to a gas process system for treating a solids-containing and/or solids-forming gas stream, wherein said gas process system comprises a device for forming a liquid film between the gas stream to be treated and an interior wall of such gas processing system, and wherein such liquid film is spaced apart from the interior wall by a distance that is sufficient to prevent solids from passing through such liquid film to form deposition on the interior wall.

### BACKGROUND OF INVENTION

1. Field of the Invention

The present invention relates to a gas processing system for processing a solids-containing and/or solids-forming gas stream, wherein said gas processing system comprises a water curtain for preventing solids deposition or formation on the interior walls thereof.

2. Background of the Related Art

For gas processing systems used for abating solids-containing and/or solids-forming gas streams released by various industrial facilities, of solids on the interior walls of such systems is frequently a problem. As the solids-containing and/or solids-forming gas stream is flowed through such gas processing system, solids may be deposited on the interior walls of such system, causing pressure increase within such system due to reduced cross-sectional area thereof.

In general, the solids associated with the gas stream to be processed can come from various sources, including: (i) solids generated in an upstream process unit which comes downstream to the inlet structure with the gas stream; (ii) solids formed in the system lines by the reaction of a process gas component with oxygen from leaks coming into the lines; (iii) solids formed in the system lines due to reaction of two or more process gas components during flow of the gas stream; (iv) solids formed by condensation of one or more process gas components coming downstream to the gas processing system; (v) solids formed by reaction of one or more process gas components with back-diffusing oxygen or water vapor from the down stream gas processing unit such as a downstream water scrubber.

The aforementioned solids deposition problem may require complex solids removal mechanisms for periodically cleaning the interior walls of the gas process system. Installation of such mechanisms not only increases the overall gas-processing costs, but the periodic cleaning also requires total shut-down of the gas processing system, which causes a decrease in productivity of such gas processing system.

U.S. Pat. Nos. 5,935,283 and 5,846,275, both assigned to Advanced Technology Materials, Inc., describe a gas processing system comprising an inlet structure for introducing the solids-containing and/or solids-forming gas stream thereinto, while such inlet structure comprises a downstream annular section for forming a falling liquid film to cover the interior wall of such gas processing system. Such liquid film functions to wash away the solids from such interior wall of the gas processing system and to prevent solids deposition or formation thereon.

Specifically, FIG. 1 shows a part of a gas process system having inlet structure 12 equipped with a liquid film forming section, which comprises spray nozzles 25 and a conical skirt 5, wherein the conical skirt 5 forms a narrow liquid flow passage 35 with the interior wall surface 30 of the gas processing system, so that liquid 40 as dispersed by the spray nozzles 25 flows down along the conical skirt 5 and through the narrow liquid flow passage 35 to form a thin liquid film 42 covering the interior wall surface 30 of the gas processing system, for flushing solids accumulated on such wall surface 30 to a downstream sump (not shown).

However, since such liquid film 42 is immediately adjacent to the interior wall surface 30, some solids 41 can still diffuse through such liquid film 42, to form deposition on the interior wall 30, and the solids deposition problem as described hereinabove is not yet completely solved.

It is therefore an object of the present invention to provide an improved gas processing system for processing and treating a solids-containing and/or solids-forming gas stream, which is resistant to solids buildup on its interior surface.

It is another object of the present invention to provide a combustion-based effluent abatement system, comprising a liquid sheath for effectively shielding the interior walls of such effluent abatement system from the heated gas generated by the combustion abatement process.

Other objects and advantages will be more fully apparent from the ensuing disclosure and appended claims.

### SUMMARY OF INVENTION

SUMMARY OF THE INVENTION The present invention in one aspect relates to a gas processing system for treating a gas stream. Such gas stream comprises a gas selected from the group consisting of solids-containing gas, solids-forming gas, and mixtures thereof, and such gas processing system comprises:

(a) an interior wall that is susceptible to solids deposition thereon; and

(b) a liquid film forming device arranged for forming a liquid film that is between the gas stream to be treated and the interior wall of the gas processing system and is spaced apart from the interior wall by a distance that is sufficient to prevent solids from passing through such liquid film and depositing on the interior wall.

The present invention in another aspect relates to a gas processing system for treating the above-described gas stream, wherein such gas processing system comprises:

(a) an interior wall that is susceptible to solids deposition thereon; and

(b) a first liquid film forming device arranged for forming a first liquid film that is between the gas stream to be treated and the interior wall of the gas processing system and is spaced apart from the interior wall by a distance; and

(c) a second liquid film forming device arranged for forming a second liquid film that flows down along the interior wall and is in direct contact therewith.

A further aspect of the present invention relates to a method for preventing solids deposition on an interior wall of a gas process system that processes a solids-containing and/or solids-forming gas stream, comprising forming a liquid film between the gas stream to be treated and the interior wall of the gas processing system, wherein such liquid film is spaced apart from the interior wall by a distance that is sufficient to prevent solids from passing through such liquid film and depositing on the interior wall of the gas processing system.

A still further aspect of the present invention relates to a method for preventing solids deposition on an interior wall of a gas process system that processes a solids-containing and/or solids-forming gas stream, comprising the steps of:

(a) forming a first liquid film between the gas stream to be treated and the interior wall of the gas processing system, wherein such first liquid film is spaced apart from the interior wall by a distance; and

(b) forming a second liquid film between the gas stream to be treated and the interior wall of the gas processing system, wherein such second liquid film flows down along the interior wall and is in direct contact therewith.

Other aspects, features and advantages of the invention will be more fully apparent from the ensuing disclosure and appended claims.

### BRIEF DESCRIPTION OF DRAWINGS

BRIEF DESCRIPTION OF THE DRAWINGS FIG. 1 shows a schematic view of a prior art gas processing system.

FIG. 2 shows a schematic view of a gas processing system according to one embodiment of the present invention.

FIG. 3 shows a schematic view of a gas processing system according to another embodiment of the present invention.

### DETAILED DESCRIPTION

DETAILED DESCRIPTION OF THE INVENTION, AND PREFERRED EMBODIMENTS THEREOF The present invention provides an improved gas processing system for processing or treating solids-containing and/or solids-forming gas stream.

The term “solids-containing and/or solids-forming gas stream”as used herein refers to a gas stream comprising a gas selected from the group consisting of solids-containing gas, solids-forming gas, and mixtures thereof.

The gas processing system of the present invention comprises an interior wall that is susceptible to solids buildup thereon. In order to completely eliminate solids buildup on such interior wall, the present invention provides a liquid film forming device that is positioned and arranged to form a liquid film that lies between the solids-containing and/or solids-forming gas stream and the interior wall but is not in direct contact with the interior wall of such gas process system. Instead, such liquid film is spaced apart from the interior wall by a distance that is sufficient to prevent solids from passing through such liquid film and depositing on the interior wall.

Preferably, such liquid film is spaced apart from the interior wall of the gas processing system by not less than 1 cm, more preferably not less than 5 cm, and most preferably not less than 10 cm.

By forming such liquid film that is spaced apart from the interior wall of the gas processing system, the present invention eliminates the possibility that a portion of the solids captured by the liquid film can “swim”across such liquid film to reach the interior wall of the gas processing system and form depositions thereon. The distance between the liquid film of the present invention and the interior wall of the gas processing system is filled with air, and the solids, in order to ever reach the interior wall, have to overcome the surface tension of the liquid film at the liquid/air interface, which greatly reduces the possibility of such solids reaching the interior wall.

Such liquid film flows preferably in a direction that is substantially parallel to the interior wall of the gas processing system. More preferably, the flow direction of such liquid film intercepts the interior wall of the gas processing system by less than 5 degrees, and most preferably less than 1 degree.

Further, the liquid used for forming such liquid film is supplied by a liquid source that may comprise any liquid that is suitable for solid-removal. For example, the liquid source may supply a liquid consisting essentially of water. Alternatively, such liquid source may comprise an aqueous solution including at least one reactant that reacts with a gaseous component of said gas stream, so the liquid film formed of such aqueous solution is capable of both solid and gas removal. Further, such liquid source may comprise an aqueous solution including at least one solid-dissolving agent, for enhancing the solid-removal performance of such liquid film so formed.

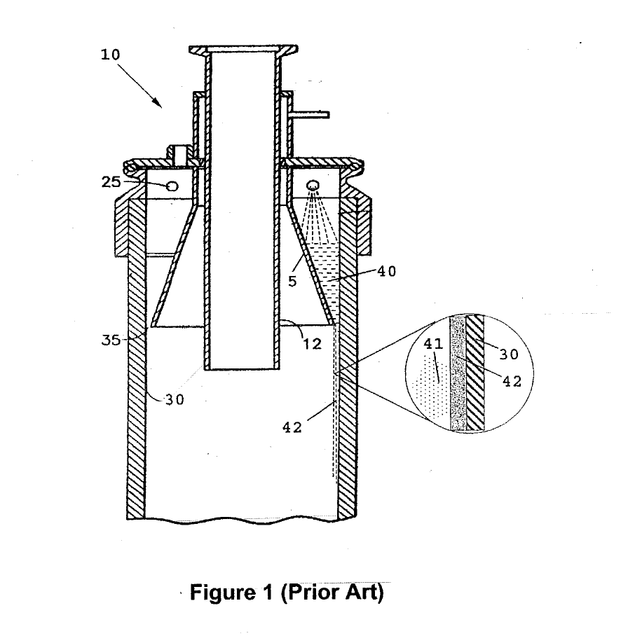

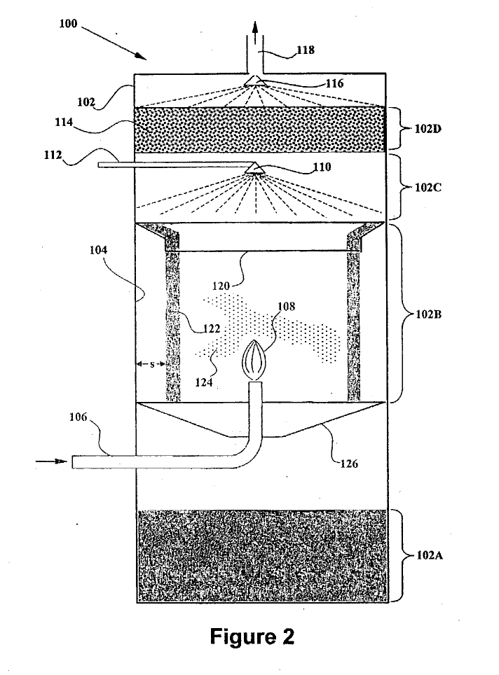

FIG. 2 shows a gas processing system 100 of the present invention, which comprises a gas processing chamber 102 having a cylindrical interior wall 104. Such gas processing chamber 102 is further divided into a sump section 102A, a combustion section 102B, a cooling section 102C, and a sorption section 102D. A gas inlet 106 introduces a solids-containing and/or solids-forming gas stream into the gas processing chamber 102, wherein such gas stream is combusted by a flame 108 in the combustion section 102B. The combustion section 102B is filled with solids 124, which are either originally contained by the gas stream, or subsequently formed during the combustion process. A liquid film forming device is provided, which comprises a liquid dispensing nozzle 110 connected with a liquid inlet 112 for introducing a liquid into such gas processing system 100, and an annular liquid channel 120 for guiding and shaping the liquid into an annular liquid film 122 that is concentric with the interior wall 104 and is spaced apart from the interior wall 104 by a distance S. Such liquid film 122 is substantially parallel with the interior wall 104, as shown by FIG. 2, forming a liquid curtain that completely shields the interior wall 104 from the solid particles 124. The liquid film 122 flows down into a liquid collecting device 126 that is connected with the sump section 102A, which may comprise a liquid outlet (not shown) for discharging the used liquid out of the system.

The liquid dispensing nozzle 110 and the liquid film 122 not only function to prevent solids deposition on the interior wall 104, but also cool the heated gas stream for subsequent processing steps. Moreover, the liquid dispensed by nozzle 110 may comprise an active ingredient that reacts with one or more gaseous components of the gas stream for removal of such gaseous components from the gas stream.

The combusted and cooled gas stream can be passed further through a sorbent bed 114 in the sorption section 102D and another counter-flow of liquid provided by a nozzle 116. Additional components can be added to such gas processing system 100, for better gas treatment results, and the structures described hereinabove are for illustration purpose only and should not be construed to limit the broad scope of the present invention.

For example, the liquid film forming device may further comprise a vertical support screen or multiple liquid channeling bars (not shown) for guiding and shaping the liquid to form a coherent liquid curtain.

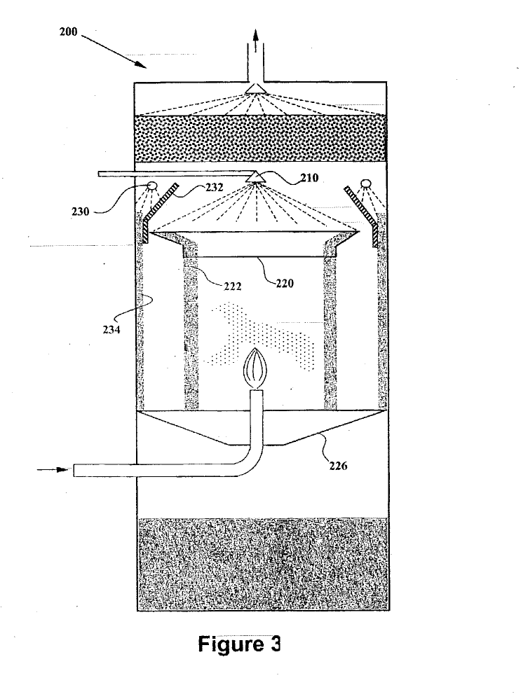

FIG. 3 shows another gas processing system 200, according to a preferred embodiment of the present invention, which comprises a first liquid film forming device positioned and arranged for forming a first liquid film 222 that is spaced apart from the interior wall of the gas processing system, and a second liquid film forming device for forming a second liquid film 234 that flows down along and is in direct contact with the interior wall of the gas processing system. The first liquid film forming device comprises nozzle 210 and liquid shaping structure 220, and the second liquid film forming device comprises nozzles 230 and the liquid shaping structure 232. Such first and second liquid films provide dual protection against solids deposition on the interior wall of the gas processing system 200.

Although the invention has been variously disclosed herein with reference to illustrative embodiments and features, it will be appreciated that the embodiments and features described hereinabove are not intended to limit the scope of the invention, and that other variations, modifications and other embodiments will suggest themselves to those of ordinary skill in the art. The invention therefore is to be broadly construed, consistent with the claims hereafter set forth.

What is claimed is:

1. A gas processing system for treating a gas stream, said gas stream comprising a gas selected from the group consisting of solids-containing gas, solids-forming gas, and mixtures thereof, wherein said gas processing system comprises:
(a) an interior wall that is susceptible to solids deposition thereon; and
(b) a liquid film forming device arranged for forming a liquid film that is between the gas stream to be treated and the interior wall of said gas processing system and is spaced apart from said interior wall by a distance that is sufficient to prevent solids from passing through said liquid film and depositing on said interior wall.

2. The gas processing system of claim 1, wherein said liquid film forming device is arranged for forming a liquid film substantially parallel to said interior wall of said gas processing system.

3. The gas processing system of claim 1, wherein said liquid forming device comprises at least one liquid dispensing nozzle connected to a liquid source, and at least one liquid shaping structure arranged in liquid receiving relationship with said liquid dispending nozzle, for receiving the liquid and shaping said liquid into said liquid film.

4. The gas processing system of claim 3, wherein the interior wall of said gas process system comprises a cylindrical wall, and wherein the liquid shaping structure comprises an annular liquid channel for shaping said liquid film into an annular film that is concentric with said interior wall.

5. The gas processing system of claim 1, further comprising a liquid supply comprising an aqueous solution including at least one reactant that reacts with a gaseous component of said gas stream.

6. The gas processing system of claim 1, further comprising a liquid supply comprising an aqueous solution including at least one solid-dissolving agent.

7. The gas processing system of claim 1, further comprising a liquid supply comprising a liquid consisting essentially of water.

8. A gas processing system for treating a gas stream, said gas stream comprising a gas selected from the group consisting of solids-containing gas, solids-forming gas, and mixtures thereof, wherein said gas processing system comprises:
(a) an interior wall that is susceptible to solids deposition thereon;
(b) a first liquid film forming device arranged for forming a first liquid film that is between the gas stream to be treated and the interior wall of said gas processing system and is spaced apart from said interior wall by a distance; and
(c) a second liquid film forming device arranged for forming a second liquid film that flows down along said interior wall of the gas processing system and is in direct contact therewith.

9. The gas processing system of claim 8, wherein both said first and second liquid film forming devices are arranged to form liquid films that are substantially parallel to said interior wall of said gas processing system.

10. The gas processing system of claim 9, wherein said first liquid forming device comprises at least one liquid dispensing nozzle connected to a liquid source, and at least one liquid shaping structure arranged in liquid receiving relationship with said liquid dispending nozzle, for receiving the liquid and shaping said liquid into said first liquid film.

11. The gas processing system of claim 9, wherein said second liquid forming device comprises at least one liquid dispensing nozzle connected to a liquid source, and at least one liquid shaping structure arranged in liquid receiving relationship with said liquid dispending nozzle, for receiving the liquid and shaping said liquid into said second liquid film.

12. The gas processing system of claim 9, wherein the interior wall of said gas process system comprises a cylindrical wall, and wherein both the first and the second liquid films are annular films that are concentric with said interior wall.

13. The gas processing system of claim 9, further comprising at least one liquid supply comprising an aqueous solution including at least one reactant that reacts with a gaseous component of said gas stream.

14. The gas processing system of claim 9, further comprising at least one liquid supply comprising an aqueous solution including at least one solid-dissolving agent.

15. The gas processing system of claim 9, further comprising at least one liquid supply comprising a liquid consisting essentially of water.

16. A method for preventing solids deposition on an interior wall of a gas process system that processes a gas stream that comprises a gas selected from the group consisting of solids-containing gas, solids-forming gas, and mixtures thereof, said method comprising forming a liquid film between the gas stream to be treated and the interior wall of said gas processing system, wherein said liquid film is spaced apart from said interior wall by a distance that is sufficient to prevent solids from passing through said liquid film and depositing on said interior wall.

17. A method for preventing solids deposition on an interior wall of a gas process system that processes a gas stream that comprises a gas selected from the group consisting of solids-containing gas, solids-forming gas, and mixtures thereof, said method comprising the steps of:
(a) forming a first liquid film between the gas stream to be treated and the interior wall of said gas processing system, wherein said first liquid film is spaced apart from said interior wall by a distance; and
(b) forming a second liquid film between the gas stream to be treated and the interior wall of said gas processing system, wherein said second liquid film flows down along said interior wall and is in direct contact therewith.
